(19) United States
(12) Patent Application Publication
(10) Pub. No.: US 2026/0230284 A1
(43) Pub. Date: Aug. 6, 2026

(54) MACHINE LEARNING-BASED, INTER-CELL NEIGHBOR RELATION MANAGEMENT IN A CELLULAR NETWORK

(71) Applicant: DISH Wireless L.L.C., Englewood, CO (US)

(72) Inventors: Mahdi Khansari, Littleton, CO (US); David Ricardo Bentolila Sapiani, Littleton, CO (US); Abbas Ali Khan, Aurora, CO (US)

(21) Appl. No.: 19/044,312

(22) Filed: Feb. 3, 2025

(51) Int. Cl. H04L 5/00; H04W 16/18; H04W 28/086; H04W 28/18

(52) U.S. Cl. CPC H04L 5/0073; H04W 16/18; H04W 28/0861; H04W 28/18

(57) ABSTRACT

A method includes determining, by a computing system for a cell of a cellular network, a boundary that depends on a direction and a type of coverage associated with the cell. The method includes determining a plurality of engineering parameters associated with neighbor relations between the cell and a plurality of neighbor cells within the boundary. The method includes inputting the plurality of engineering parameters to a machine learning model trained to estimate a probability that each neighbor cell of the plurality of neighbor cells is a related neighbor cell for purposes of cellular device handoffs. The method includes storing, by the computing system, in a neighbor relation database in memory, an identity of each neighbor cell having a probability that satisfies a threshold probability for the cell.

### BACKGROUND

Telecommunication networks, such as cellular networks, have various resources that produce data and metadata concerning operations of the cellular network. Metadata is data that provides information about data. Metadata enriches the data with information about one or more aspects of the data. Metadata insights can facilitate efficient processing and understanding the data, to include data generated by code executed to perform applications that support cellular networks. Status reports, including error codes, may be generated which are indicative of deficiencies in operations of the network, including deficiencies in network capacity, network connectivity, and application performance.

With the development of communication technologies, such as fifth generation (5G) new radio (NR) cellular networks, applications supporting a massive number of connected devices are enabled over a distributed computing platform, which is typically supported by cloud computing. Such applications can be executed from code or software functions from myriad sources, including proprietary sources to a 5G network and to third-party sources.

Efforts to automate data processing and generating insights into capacity or performance deficiencies is challenging in 5G cellular networks because the structure of each 5G network (or each portion of the 5G network) is unique, particularly with third-party applications mixed in, requiring different specification and adaptation modifications. These different modifications lead to frequent changes in application deployments, e.g., software code or computer images developed by network engineers. Current computing platforms lack the flexibility to adapt to these ongoing network modifications.

### BRIEF DESCRIPTION OF DRAWINGS

The present disclosure is illustrated by way of example, and not by way of limitation, in the figures of the accompanying drawings.

FIG. 1A is a block diagram of a cellular network system including a computing system in or associated with the cellular network for purposes of adaptive and scalable computing to support the cellular network according to at least one embodiment.

FIG. 1B is a block diagram of the computing system of FIG. 1A according to some embodiments.

FIG. 2 is a block diagram of an example computing system configured as an adaptive cellular network computing platform with scalable execution nodes according to some embodiments.

FIG. 3A is a pictorial representation of a compute function that may be encapsulated within a job to be performed by the disclosed computing system according to some embodiments.

FIG. 3B is a pictorial representation of a job that incorporates multiple compute functions (such as the compute function of FIG. 3A) to execute aspects of applications in support of the cellular network according to some embodiments.

FIG. 4A is a flow diagram of a method for training a machine learning (ML) model to identify and manage neighbor cell relations according to some embodiments.

FIG. 4B is a flow diagram of a method for employing the trained ML model (from FIG. 4B) to infer related neighbor cells to a particular cell of the cellular network according to some embodiments.

FIG. 5 is a flow chart of an example method for identifying related neighbor cells of the particular cell within the cellular network using the ML model according to some embodiments.

FIG. 6 illustrates a plurality of indicators for cells and sectors of an active site of the cellular network presentable through a user interface (UI) according to some embodiments.

FIG. 7A illustrates a technique for identifying a boundary for a cell useable to identify neighbor cell relations of a plurality of neighbor cells according to at least some embodiments.

FIG. 7B illustrates determining a bearing angle between the cell and each respective neighbor cell of a plurality of neighbor cells according to some embodiments.

FIG. 7C illustrates determining a difference angle between a first azimuth of the cell and a second azimuth of each respective neighbor cell according to some embodiments.

FIG. 7D illustrates determining a distance between the cell and each respective neighbor cell of the plurality of neighbor cells.

FIG. 8 illustrates a block diagram illustrating an exemplary computer device (or computing device), in accordance with implementations of the present disclosure.

### DETAILED DESCRIPTION

Further to the above discussion, as a particular example of a network application, automatic neighbor relations (ANR) is an automated function used by engineers attempting to identify which neighbor cells are sufficiently “related” to be connected for purposes of seamless handovers between cells as a cellular device moves between the cells. The ANR function can be executed from a 5G cellular base station (gNodeB) in order to manage a neighbor relation table (NRT), which can be updated with current neighbor cell relations for purposes of cellular device handoffs. While the ANR function has sped up the process of adding and removing neighbor relations, issues such as site propagation problems (e.g., cells that overshoot or undershoot cellular coverage of neighbor cells) can cause ANR to define either too many or too few neighbors than needed for robust cellular coverage for cellular devices while on the move.

Aspects and embodiments of the present disclosure overcome the above-mentioned deficiencies and others by implementing enhancements to existing (or legacy) cellular network stations, which enhancements can be integrated with or coupled to each cellular network station. Such enhancements can include improvements over existing ANR functions to resolve the above-mentioned deficiencies in updating neighbor relations. In various embodiments of such improvements, inter-cell neighbor relations can be determined by first training a machine learning model to estimate a probability that each neighbor cell to a particular cell is a related cell for purposes of cellular device handoffs between cells, e.g., handoffs between cellular stations that include neighbor cells.

As mentioned, the present embodiments are particularly directed to 5G networks, but later generation cellular networks (e.g., 6G, 7G, etc.) are also envisioned and are applicable. In at least some embodiments, an additional computing system (e.g., one or more servers) can be configured to provide the flexibility to user devices requesting jobs to select from different compute functions (that are to be executed as part of each job) and that enables scaling of execution nodes to handle a varying number of jobs that are queued in a job queue. Although reference herein is to execution nodes, the principles disclosed herein can be applied to compute or agent nodes consistent with the functions described below.

In some embodiments, job requests involve resource requests associated with the functionality of the cellular network, e.g., by specific users (such as user devices of design engineers), a Web application executing on the cellular station that provides access to cloud-based functionality of the cellular network, and/or an administrator devices that oversee the cloud computing and security aspects of the cellular network. For example, the jobs can be customized to perform specification and adaptation modifications to proprietary or third-party applications being executed in the cloud-based environment of the cellular network station. Some modifications can be employed to resolve network errors, such as connectivity-related issues, capacity-related issues, or to improve application functionality or performance.

In some embodiments, one or more processing devices of the computing system are configured to receive, from a cellular network station, a job request via a user interface (UI) configured to communicate with the cellular network station. The UI can, for example, be a graphical user interface (GUI) adapted for web application access. In embodiments, the job request includes data that specifies one or more compute functions to be executed for a job and a scheduled time for execution of the job. The computing system can further store, by the UI, in memory, the job request with the data. In this way, the UI streamlines receipt and storage (or buffering) of incoming jobs. In some embodiments, these job requests include requests to update neighbor relations between cells in a particular portion of the cellular network.

In embodiments, the computing system, which gets alerted to new jobs in the memory, can retrieve, from the memory, the job request and the data. The computing system can insert the job, associated with the job request, in a job queue so as to be executed by the scheduled time. The computing system can then determine, based on one or more metric values associated with a plurality of jobs in the job queue, whether to expand or reduce a number of execution nodes activated to execute the one or more compute functions of the plurality of jobs in the job queue. In some embodiments, an auto scaler, executed by the computing system, determines the metric value(s) based on information provided by the job queue. For example, the metric value(s) can include how many jobs are in the job queue, how long the jobs are expected to take to execute, and/or how many jobs have failed to execute that still reside in the job queue.

In at least some embodiments, the computing system further executes, by a execution node of the number of execution nodes, the one or more compute functions for the job to generate one or more output values. The computing system can then trigger, with the output values, an external actuator associated with a 5G cellular network to which the 5G cellular station belongs. In embodiments, the external actuator is to provide the one or more output values to one of a cellular network component or a cellular network subscriber. The external actuator can be an external application programming interface (API) of an element management system (EMS), a file storage, an external database, or an email server (or other types of servers), for example.

In some embodiments, one or more computing nodes (e.g., one or more processing devices backed up by memory) of the computing system can be configured to perform neighbor cell relations management as described herein. Neighbor relations refer to the configuration and management of relationships between neighboring cells in the cellular network. These relationships help to ensure seamless communication, efficient handovers, and optimal performance in 5G (or related) networks. Each cell can identify and monitor neighboring cells to facilitate handovers for users moving across cell boundaries, e.g., by providing a list of related neighbor cells to cellular devices from which to choose the cell with the strongest signal. Neighboring cells can be defined by their physical cell identifiers (PCI) and other attributes or parameters, as will be discussed. Proper neighbor relations enable smooth handovers between cells, reducing dropped calls, and ensuring uninterrupted data sessions.

For example, in some embodiments, the computing system determines, for a cell of the cellular network, a boundary that depends on a direction and a type of coverage associated with the cell and determine a plurality of engineering parameters associated with neighbor relations between the cell and a plurality of neighbor cells within the boundary. In embodiments, the computing system inputs the plurality of engineering parameters to a machine learning model trained to estimate a probability that each neighbor cell of the plurality of neighbor cells is a related neighbor cell for purposes of cellular device handoffs. The computing system can detect, in outputs of the machine learning model, the identity of each neighbor cell having a probability that satisfies (e.g., at least matches) a threshold probability for the cell. The computing system can further store, in a neighbor relation database in memory, an identity of each neighbor cell having the probability satisfying a threshold probability for the cell.

Particular implementations of the subject matter described in this disclosure can be implemented so as to realize one or more of the following advantages. For example, the disclosed computing system can provide additional flexibility and ability to scale by dynamically activating execution nodes to execute a particular number of jobs in the job queue. Further, as discussed, the computing system can provide the ability of users (e.g., via user devices) to customize these jobs by selecting, via a UI or GUI, particular proprietary and/or third-party compute functions to be performed for each job.

Additionally, at least some of these jobs can trigger updating neighbor relations of a particular cell, so that neighbor relations are as accurate as possible, overcoming conventional ANR techniques discussed previously. Proper neighbor relations enable smooth handovers between cells, reducing dropped calls, and ensuring uninterrupted data sessions. Properly configured cellular neighbor relations enable optimizing network performance, improving user experience, and maintaining connectivity in high-speed and dense urban environment. These and other solutions and advantages will be discussed in more detail.

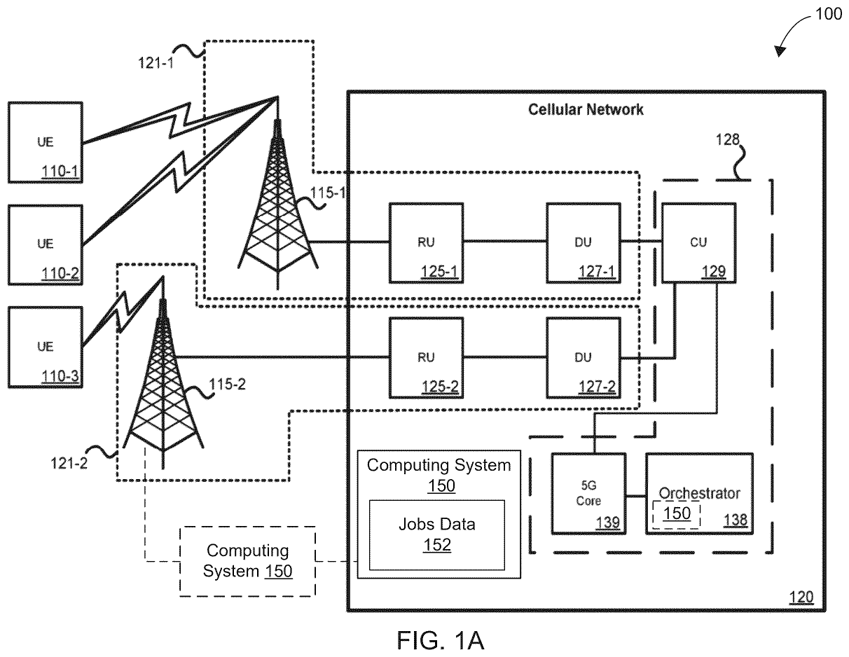

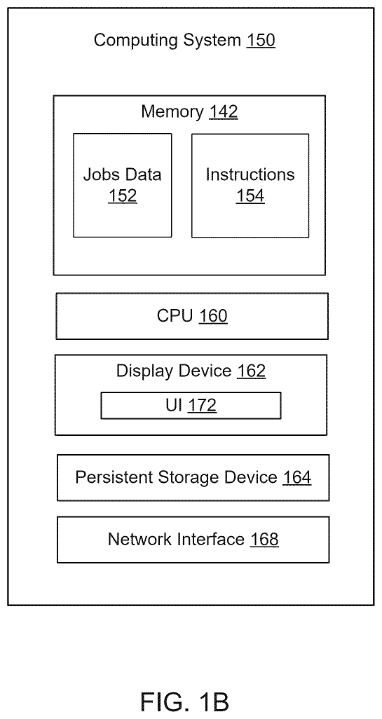

FIG. 1A is a block diagram of a cellular network system 100 including a computing system 150 in or associated with the cellular network for purposes of adaptive and scalable computing to support the cellular network according to at least one embodiment. FIG. 1A represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station structure 115; cellular network 120; radio units 125 (“RUs 125”); distributed units 127 (“DUs 127”); centralized unit 129 (“CU 129”); 5G core 139, and orchestrator 138. FIG. 1A represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), and other computerized devices capable of communicating via a cellular network, etc. Generally, UE 110 can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. Although more are envisioned, two base stations 121-1 and 121-2 are illustrated. In embodiments, base station 121-1 can include structure 115-1, RU 125-1, and DU 127-1, where structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs and 5G core 139. Each structure 115 can include one or more antennas that allow RUs 125 to communicate wirelessly with UEs 110. RUs 125 can each represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1 and DU 127-2, may communicate with CU 129. Collectively, an RU, DU, and CU create a gNodeB, which serves as the radio access network (RAN) of cellular network 120. CU 129 can communicate with the 5G core 139. The specific architecture of the cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1A illustrates various components of cellular network 120, other embodiments of cellular network 120 can vary the arrangement, communication paths, and specific components of cellular network 120, which will be expanded on in subsequent Figures. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so it may be desired to avoid allocation of an excess of resources to a particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing can be performed.

The 5G core 139, which can be physically distributed across data centers or located at a central national data center (NDC), can perform various core functions of the cellular network. The 5G core 139 can include: network resource management components; policy management components; subscriber management components; and packet control components, among others. Individual components may communicate on a bus, thus allowing various components of 5G core 139 to communicate with each other directly. The 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

As illustrated in FIG. 1A, the system 100 includes a computing system 150 or data platform. The computing system 150 can be distrusted in some embodiments and include a suite of tools and technologies designed to manage, store, process, analyze, and/or visualize large volumes of data, including execution of software applications that carry out aspects of the cellular network (e.g., in the cloud). In varying embodiments, the computing system 150 is located in or implemented as part of the orchestrator 138, is located within the cellular network 120 but outside of the main cellular network components 128, or is located outside of the cellular network 120 but is capable of monitoring data such as capacity and connectivity information by connecting to the cellular network 120 in similar ways that does a server or other networked computing system.

In at least one embodiment, the computing system 150 is a distributed set of processing devices located in one or more of these three locations that can share one or more memory or storage devices that are capable of storing jobs data 152 (see FIG. 1B). In embodiments, the jobs data 152 is associated with execution of software applications and other functionality carried out for the cellular network 120, as will be described in more detail. The computing system 150 can aggregate and track such job data 152 for purposes of executing various jobs of the cellular network 120 associated with the jobs data.

In some embodiments, the computing system 150 is used by modern data-driven organizations, enabling them to harness the power of their data for various purposes, such as business intelligence, analytics, machine learning, and more. In general, the computing system 150 includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The computing system 150 can include data storage components, such as data lakes, data warehouses, database systems. Data lakes are large storage repositories that hold raw data in its native format until it is needed. Data warehouses is structured storage systems optimized for query performance and analytics, often storing cleaned and processed data. Database Systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring.

Data management components can handle metadata management and data governance. The metadata management can include tools for managing metadata, which is data about data, including data catalogs, lineage, and governance. Data Governance can include policies and processes to ensure data quality, security, privacy, and compliance with regulations. Data integration components can provide application programming interfaces (APIs), data virtualization, etc. The APIs can be used for accessing and integrating data across different systems. Data Virtualization techniques can be used for abstracting and integrating data from various sources without moving it physically. The data analytics components can have Business Intelligence (BI) and advanced analytics tools and platforms for data reporting, visualization, and dashboards to support decision-making. Advanced analytics techniques, like data mining, predictive analytics, and statistical analysis, can be used to derive deeper insights. The ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches.

The computing system 150 can consolidate data from various sources into a single platform, making it easier to manage and access. The computing system 150 can support large-scale data storage and processing, accommodating growing data volumes and increasing complexity. The computing system 150 can enable real-time data processing and analytics, allowing organizations to respond quickly to changing conditions. The computing system 150 can facilitate collaboration across different departments and teams by providing a unified data environment. The computing system 150 can implement data governance and quality control measures to ensure the accuracy and reliability of data. The computing system 150 can provide organizations with the tools and insights needed to make informed, data-driven decisions. In summary, the computing system 150 can provide the infrastructure and tools needed to manage, process, and analyze data effectively, enabling organizations to unlock the full potential of their data assets. The computing system 150 can also provide business intelligence and reporting. The computing system 150 can aggregate data from multiple sources to generate comprehensive reports and dashboards for business analysis. The computing system 150 can provide real-time analytics. In particular, the computing system 150 can monitor and analyze data streams in real-time to gain immediate insights and drive instant actions. The computing system 150 can provide customer insights by analyzing customer data to understand behavior patterns, preferences, and trends to improve customer experience and loyalty. The computing system 150 can implement predictive maintenance as well, such as using machine learning models to predict equipment failures, capacity deficiencies, and schedule proactive capacity solutions and/or maintenance.

FIG. 1B is a block diagram of the computing system 150 of FIG. 1A according to some embodiments. In at least some embodiments, the computing system 150 includes memory 142, a central processing unit (CPU) or other processor, a display device 162, a persistent storage device 164, and a network interface 168. The memory 142 (as well as the persistent storage device 164) can store jobs data 152 and instructions 154. The CPU 160 can include one or more processing devices in the case that the computing system 150 is distributed, while the memory 142 and the persistent storage devices 164 (among other components) may or may not be distributed, e.g., located across different locations of a network such as the cellular network 120 or within the cloud with which the cellular network 120 communicates.

For example, in embodiments, the computing system 150 is implemented in a cloud computing system, providing data storage, data warehousing, real-time data processing, analytic engines for large-scale data processing, ML/AI services, data flow for stream and batch processing, or other data services. As described in more detail below, the computing system 150 can provide and present a UI 172 (or GUI) within the display device 162 in connection with executing jobs associated with cellular network applications. Management of job execution may be instantiated within the instructions 154, which when executed by the one or more processing devices of the CPU 160, presents the UI 172 with compute function options that users can select, e.g., that are from proprietary and/or third-party sources. Once selected, for example, the compute function can be combined into one or more jobs that will be discussed in more detail hereinafter. In some embodiments, the UI 172 includes, in connection with the CPU 160, a framework capable of generating and/or modifying executable code (represented by graphical objects in a GUI) for utility programs, applications, functions, routines, scripts, processing pipelines, solutions, connector functions, object stores, enterprise integration tools, or other executable code associated with network software.

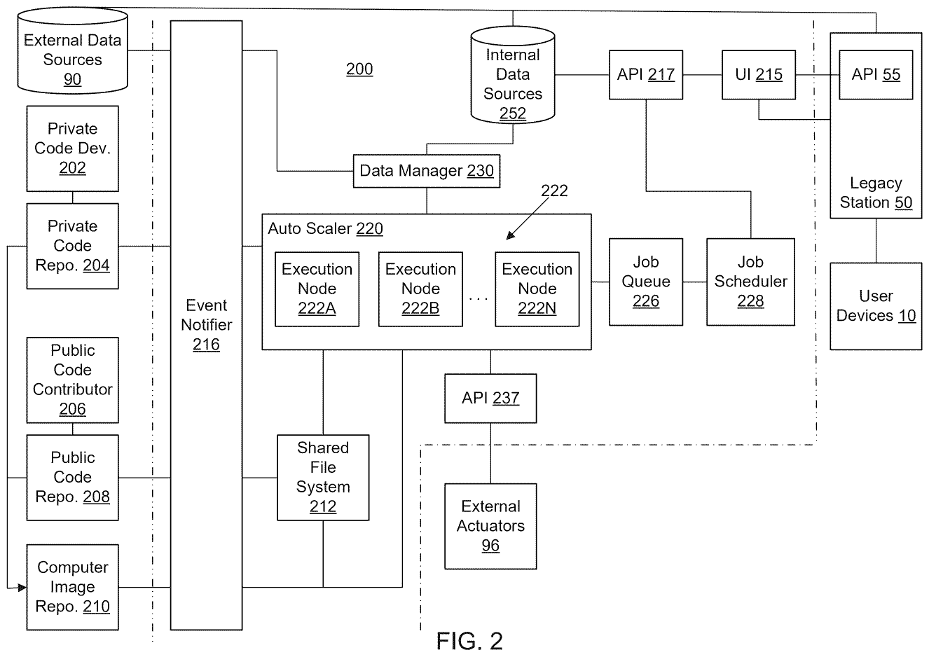

FIG. 2 is a block diagram of an example computing system 200 configured as an adaptive cellular network computing platform with scalable execution nodes according to some embodiments. In such embodiments, the computing system 200 is a specialized version of or an integration with the computing system 150 of FIGS. 1A-1B.

In at least some embodiments, the computing system 200 is coupled to a cellular network station 50 through which user devices 10 communicate to perform updates to or trigger execution of software code via job execution as will be explained. The cellular network station 50 can be a legacy 5G cellular network station for example that already exists and that is enhanced by the computing system 200. The user devices 10 can be of different types, such as those operated by network design engineers, those accessing a Web application executed by the cellular network station 50 that provides access to cloud-based functionality of the cellular network 120, and/or administrator devices that oversee the cloud computing and security aspects of the cellular network 120.

In various embodiments, the computing system 200 includes or is coupled to external data sources 90, a private code repository 204, a public code repository 208, and a computer image depository 210. In some embodiments, computer images associated with software code stored in the repositories 204 and 208 are stored in the computer image repository 210. Examples of the external data sources 90 include Redshift and Snowflake databases, but others are envisioned. Amazon® Redshift is a cloud-based data warehouse service offered by Amazon® Web Services (AWS®). Redshift is designed for big data analytics and enables users to store and analyze vast amounts of structured and semi-structured data. Snowflake® is a cloud-native data warehouse and analytics platform. Unlike traditional data warehouses, Snowflake® is platform-independent and runs on multiple cloud providers, including AWS®, Google® Cloud, and Azure®. While various AWS® and other similar services are discussed herein, these are examples for purposes of explanation of the types of services that the computing system 200 can employ to perform certain actions or functions.

A private code developer machine 202 can be coupled to the private code repository 204 and be able to store codes (e.g., software code) developed by private developers in the private code repository 204. Thus, in some embodiments, the private code repository 204 includes a codebase for execution nodes, a scheduler system, and other private nodes of the computing system 200. A public code contributor machine 206 can be coupled to the public code repository 206 and be able to store reuseable compute functions developed by public contributors and engineers in the public code repository 206. Examples of these repositories 204 and 208 includes Gitlab code repositories.

The computing system 200 can include an auto scaler 220 having a scalable number of execution nodes 222 that are selectively activatable, e.g., to include one or more of a first execution node 222A, a second execution node 22B, up to an Nth execution node 222N. In some embodiments, the auto scaler 220 is an Auto Scaling Group (ASG) of AWS® or other similar scaler component of other cloud-based platforms. Different aspects of the computing system 200 can therefore employ Elastic Compute Cloud (EC2). EC2 is a core service of AWS® that provides scalable virtual servers in the cloud. EC2 allows users to launch and manage virtual machines, known as instances, to run various workloads, ranging from simple web applications to complex enterprise systems. In some embodiments, the execution nodes 222 are different virtual machines that are selectively activated (e.g., mounted) using a computer image from the computer image repository 210. As such, in other embodiments, the auto scaler 220 can instead be Azure's Virtual Machine Scale Sets (VMSS), Google's Cloud Platform (GCP), IBM's cloud autoscaling for virtual servers, Oracle's Cloud Infrastructure (OCI) autoscaling, Alibaba's cloud autoscaling, or the like.

The computing system 200 can also include internal data sources 252, e.g., internal memory and/or computer storage that stores database(s). In embodiments, the internal data sources 252 include at least a portion of a relational database, elastic file system (EFS) data, a secrets database, and/or a Dynamo database (DynamoDB). The computing system 200 can include a data manager 230 coupled between the auto scaler 220, the external data sources 90, and the internal data sources 252. As such, the internal data sources 252 can be supported by or resident in the memory 142 and/or the persistent storage device 164, as discussed with relation to the computing system 150 of FIGS. 1A-1B. The internal data sources 252 can store job requests that includes job data and a scheduled time for which each job to be completed. In varying embodiments, job requests involve resource requests associated with the functionality of the cellular network, e.g., by specific users from the user devices 10. For example, the jobs can be customized to perform specification and adaptation modifications to proprietary or third-party applications being executed in the cloud-based environment of the cellular network station 50. Some modifications can be employed to resolve network errors, such as connectivity-related issues, capacity-related issues, or to improve application functionality or performance of the cellular network 120.

For example, continuing with the AWS® example, the database manager 230 can be configured to employ different services that support cloud-based management of the auto scaler 220 and other cloud-based functionalities to be discussed. In varying embodiments, the database manager 230 includes an EFS manager configured with EC2 capability. Amazon's EFS is designed to provide serverless, fully elastic file storage that enables sharing file data without provisioning or managing storage capacity and performance. The database manager 230 can further support Amazon's Relational Database Service (Amazon RDS®), a managed database service from AWS®. Amazon RDS® allows users to set up, manage, and scale relational databases in the cloud. DynamoDB™ is a serverless, NoSQL database service in AWS® that allows developers to build applications that can scale globally. The database manager 230 can further include a secrets manager that coordinates use of cryptology and security processes to secure data being processed and transported by the computing system 200 and the cellular network 120. Other databases and database services in other cloud compute platforms are envisioned.

In some embodiments, the computing system 200 includes a UI 215 coupled to a first API 217, which is coupled to the internal data sources 252. In embodiments, the UI 215 is configured to communicate with the cellular network station 50 and the first API 217 is configured to facilitate functionality of receiving job requests from the user devices 10 via the UI 215 and store the job request, with accompanying data, in the internal data sources 252. The accompanying data of the job request, for example, can specify (or identify) one or more compute functions to be executed for a job and a schedule time for execution of the job. The cellular network station 50 can also include an API 55 that facilitates, from the cellular network station 50 side, communicating with the UI 215 and the first API 217 of the computing system 200 to streamline selection of particular compute functions to be combined into jobs to be executed by the execution nodes 222.

In at least some embodiments, the computing system 200 includes (or is coupled to) a shared file system 212 that can store imported compute functions from the public code repository 208 and/or computer images from the computer image repository 210. The computing system 200 can include an event notifier 216 configured to alert the auto scaler 220 and optionally other components of the computing system 200 of updates to particular codes stored in the private code repository 204, to compute functions stored in the public code repository 208, and/or to computer images stored in the computer image repository 210. For example, in some embodiments, the event notifier 216 is configured with notification EC2 of AWS®, which include notifications that can be configured for events related to EC2 instances. These notifications can provide alerts or trigger automated responses when certain events occur, such as instance state changes, scheduled events, system health issues, auto scaling actions, spot instance interruption noticers, or the like.

The computing system 200 can further include a job queue 226 coupled to the auto scaler 220 and a job scheduler 228 coupled between the first API 217 and the job queue 226. In some embodiments, after the job requests and accompanying jobs data is stored in the internal data sources 252, the job scheduler 228 retrieves the job request and the data and inserts the job, associated with the job request, in the job queue 226. For example, the job scheduler 228 can read an internal database (stored as an internal data source 252) every certain number of seconds for updates. The job scheduler 28 can then work to schedule and queue new jobs as the stored job requests are detected.

As jobs are queued, the auto scaler 220 can determine, based on one or more metric values associated with a plurality of jobs in the job queue 226, whether to expand or reduce a number of execution nodes 222 activated to execute the one or more compute functions of the plurality of jobs in the job queue 226. An execution node of the execution nodes 222 can execute the compute function(s) for the job to generate one or more output values. In embodiments, the auto scaler 220 determines the metric value(s) based on information provided by the job queue 226. For example, the metric value(s) include at least one of how many jobs are in the job queue, how long the jobs are expected to take to execute, or how many jobs have failed to execute.

In some embodiments, the computer storage (e.g., the memory 142 and/or persistent storage device 164) is configured to store the private code repository 204 that includes executable code developed by private system developers for scheduling the plurality of jobs in a job queue 226 and for executing the plurality of jobs by the execution nodes 222. The computer storage can also be configured to store the public code repository 208 including reusable compute functions developed by public contributors and engineers. In embodiments, the computing system 200 exposes, via the UI 215, the executable code and the reusable compute functions for access by user devices in generating each job request.

The computing system 200 can further include a second API 237 coupled between the auto scaler 220 and external actuators 96. In embodiments, the API 237 triggers, with the output value(s), an external actuator 96 associated with the cellular network 120 to which the cellular network station 50 belongs. In embodiments, the external actuator 96 provides the output value(s) to one of a cellular network component or a cellular network subscriber. For example, the external actuator 96 can be one of an external application programming interface (API) of an element management system (EMS), a file storage, an external database, an email server, or the like. An EMS can be understood as a vendor gateway to communicate with RF equipment (such as the UEs, RUs, DUs, or CU of FIG. 1A).

For example, EMSs can configure RF equipment, optimize the RF equipment, and troubleshoot RF equipment. In some embodiments, an EMS is configured as an API that enables triggering internal functions to implement changes. These APIs allow developers to modify 5G equipment configurations without the need for direct interaction with the hardware. For example, for purposes of explanation, a remote electrical tilt (RET) imparted to an antenna of the cellular network causes a horizontal azimuth to change and can impact an area covered by that antenna. Such RET adjustments can optimize signal coverage and capacity within the cellular network 120. Each antenna can be equipped with an RET motor, which adjusts its electrical tilt through a motorized control system. This RET can be managed directly by the EMS or via associated APIs. A developer or application that needs to adjust the RET can interface with the EMS API, which then triggers the necessary changes to the RET control.

In embodiments, EMS APIs enable the computing system 200 to implement changes seamlessly. In some embodiments, the computing system 200 executes a machine learning model to determine that an antenna needs to be down-tilted by a certain number of degrees. This adjustment can be made by sending a command directly via the EMS API to the site and antenna, assuming such remote control is activated at the site by a vendor of the antenna, for example.

In various embodiments, after the EMS API is selected, the computing system 200 provides the necessary parameters (such as antenna name and identifier, RET serial number, desired tilt value, and the like) and calls the API with this information. The EMS API can then process this command, locates a site computer with the target antenna (e.g., using an IP address of the site), and converters the API request into a command compatible with the operating system of the site computer. The site computer can then receive the command, translate the command into a signal for the antenna motor, and send the signal to the antenna motor to execute the RET change. The site can monitor a status of the motor and send feedback to the EMS associated with execution of the tilt change. The computing system 200 can log and/or display a confirmation of successful adjustment of the e-tilt of the antenna. Other such work flows different cellular components and parameters are envisioned.

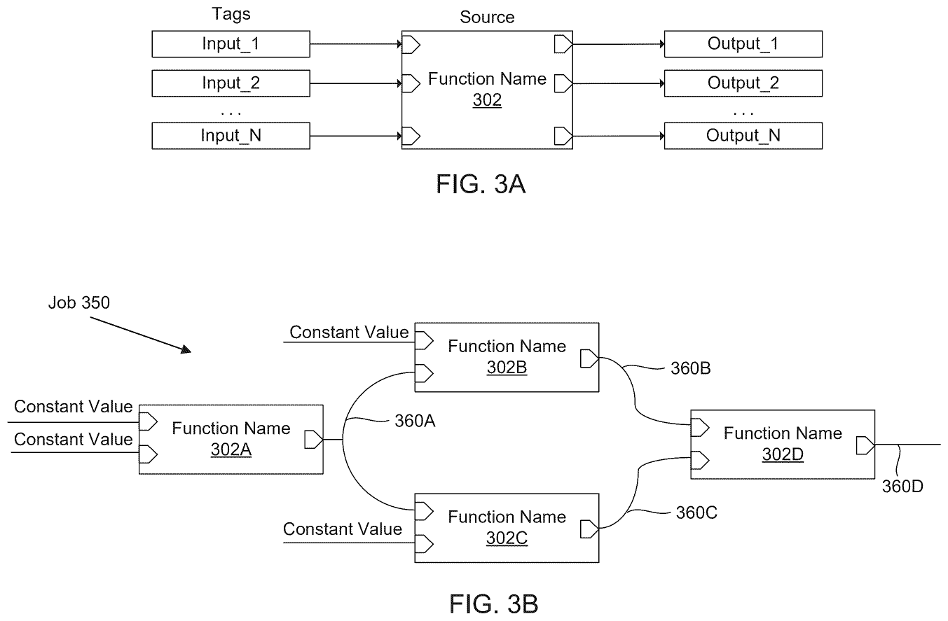

FIG. 3A is a pictorial representation of a compute function 302 that may be encapsulated within a job to be performed by the disclosed computing system according to some embodiments. In embodiments, the compute function 302 has a plurality of inputs and a plurality of outputs. FIG. 3B is a pictorial representation of a job 305 that incorporates multiple compute functions (such as the compute function 302 of FIG. 3A) to execute aspects of applications in support of the cellular network according to some embodiments.

FIG. 3B merely displays an example of a set of cascaded compute functions that make up the job 350, as those skilled in the art can appreciate many different combinations of different compute functions to form many different jobs or job types. For example, the job 350 includes a cascaded execution of a first compute function 302A, a second compute function 302B, a third compute function 302C, and a fourth compute function 302D. In this example, the first compute function 302A operates on two constant values received as input and generates a first output value 360A. The second compute function 302B operates on a constant value and the first output value 360A received from the first compute function 302A to generate a second output value. The third compute function 302C operates on a constant value and the first output value 360A received from the first compute function 302A to generate a third output value 360C. The fourth compute function 302D can then operate and the second output value (from the second compute function 302B) and the third output value (from the third compute function 302C) to generate a fourth output value 360D. In this way, an output of at least one compute function of the one or more compute functions of a job is used as an input by at least a second compute function of the one or more compute functions.

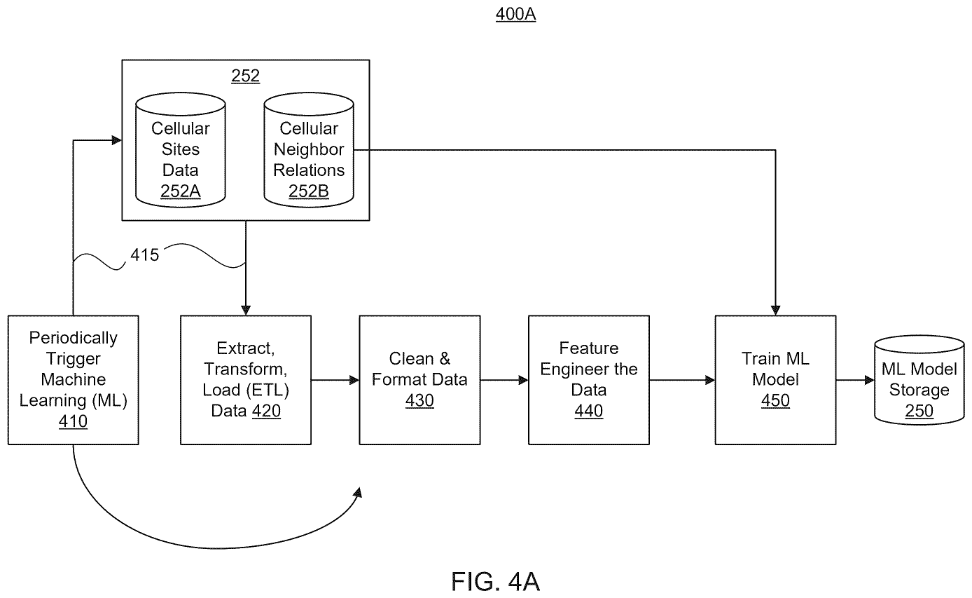

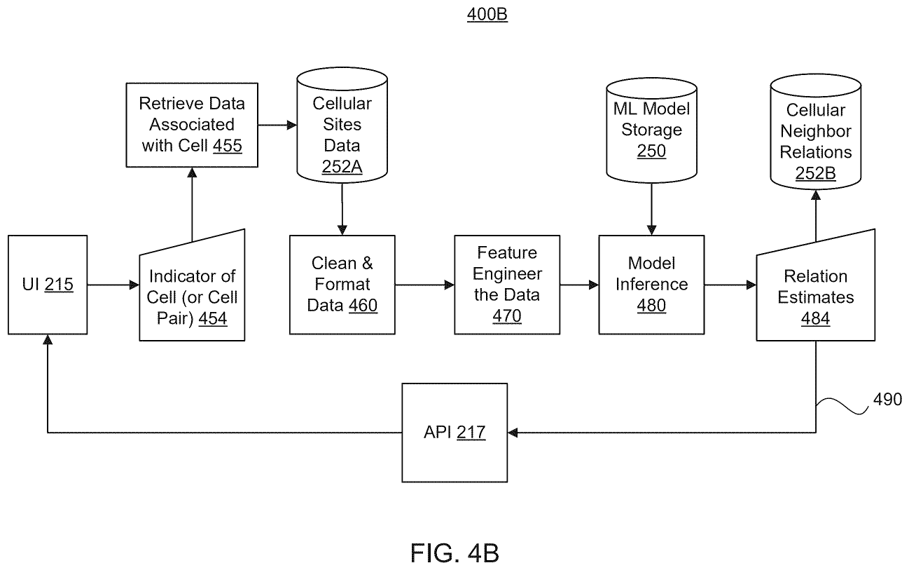

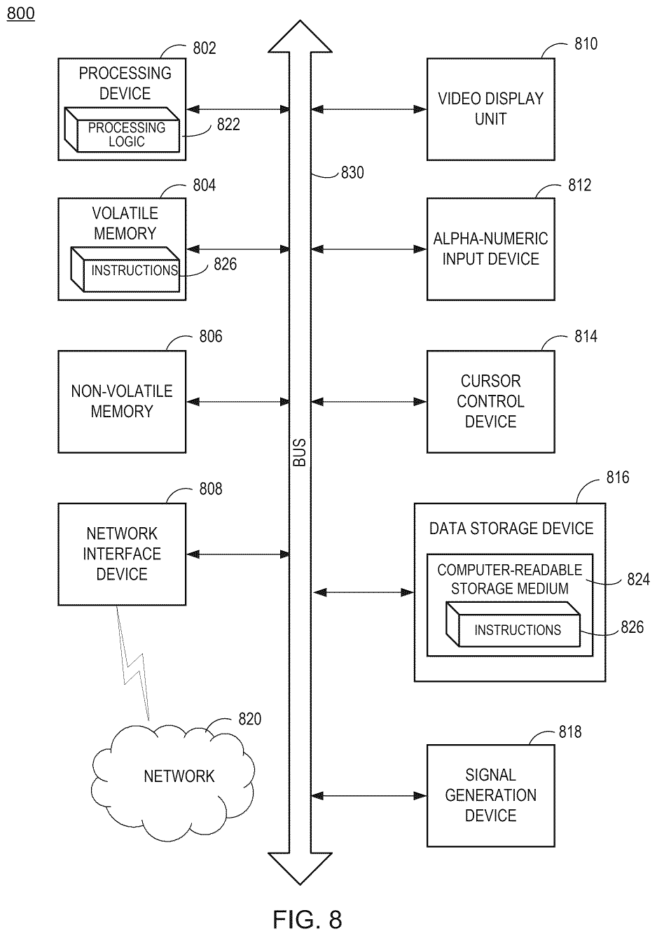

FIG. 4A is a flow diagram of a method 400A for training a machine learning (ML) model to identify and manage neighbor cell relations according to some embodiments. The method 400A may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400A is performed by the computing system 150 of FIGS. 1A-1B or the computing system 200 of FIG. 2. The method 400A can also be performed by other computing systems described herein, such as described with reference to FIG. 8. The operations of the method 400A can be performed in an order other than that specifically illustrated and may be performed with fewer than all operations.

At operation 410, the processing logic periodically triggers machine learning of the ML model so that the ML model learns how to convert a plurality of engineering parameters into determining which of a plurality of neighbor cells are sufficiently related, e.g., are related cells for purposes of cellular device handoff between cells. The plurality of engineering parameters can include a combination of site locations, antenna tilts, antenna azimuths, and frequency bands for the cell and for a plurality of neighbor cells, for example. In one embodiment, the ML model is a KERAS sequential neural network model with an Adam optimizer, but many other neural networks or similar models are envisioned. For example, in varying embodiments, the ML model is instantiated as a neural network having hundreds of inputs (certain ones of the engineering parameters), multiple layers (e.g., 2, 4, 8 plus layers), and an output that specifies an estimated probability of being a related neighbor cell.

Upon triggering machine learning, at operation 415, the processing logic retrieves updated data from a cellular sites database 252A that stores the engineer parameters. The processing logic also retrieves, from a cellular neighbor relations database 252B, initial predictions of cell relationships between the plurality of neighbor cells, which can be a starting point for learning. In embodiments, the cellular sites database 252A and cellular neighbor relations database 252B are stored in the internal data sources 252 (FIG. 2).

At operation 420, the processing logic extracts, transforms, and loads (ETL) the data having the plurality of engineering parameters retrieved from a portion of the cellular network 120 in which neighbor relations are known. In embodiments, ETL is a process of transferring and applying initial data management tasks, e.g., performed for moving and processing data between systems. In some embodiments, operation 420 is performed in an AWS® Glue task.

At operation 430, the processing logic cleans data errors and converts or formats the data into a proper format from which the plurality of engineering parameters are generated for input to the machine learning model. The cleaning can include data type checks, null handling, and outlier removal. This cleaning and formatting can result in formatted data ready to undergo feature engineering at operation 440. In some embodiments, operation 430 is also performed in an AWS® Glue task.

At operation 440, the processing logic feature engineers the formatted data which can include adding data insights to the formatted data and creating input data having structured features prepared to undergo machine learning related to those features. In some embodiments, operation 440 is also performed in an AWS® Glue task.

At operation 450, the processing logic performs machine learning on the feature-engineered data from operation 440, to train a ML model, which is stored in a ML model storage 250. In embodiments, the ML model storage 250 is volatile memory, non-volatile memory, or a combination thereof and configured to manage, order, and store trained ML models. The computing system 200 may include cellular neighbor relations, which are stored in the cellular neighbor relations database 252B, in known portions of the cellular network 120. Some of these known cellular neighbor relations can also be employed, at operation 450, in performing supervised training of the ML model. In some embodiments, the machine learning of the ML model is performed offline.

FIG. 4B is a flow diagram of a method 400B for employing the trained ML model (from FIG. 4B) to infer related neighbor cells to a particular cell of the cellular network according to some embodiments. The method 400B may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400B is performed by the computing system 150 of FIGS. 1A-1B or the computing system 200 of FIG. 2. The method 400B can also be performed by other computing systems described herein, such as described with reference to FIG. 8. The operations of the method 400B can be performed in an order other than that specifically illustrated and may be performed with fewer than all operations.

At operation 454, the processing logic receives, via a user interface (such as the UI 215), selection of an indicator of the cell for which to obtain neighbor relation predictions. This cell may be the particular cell for which neighbor relations are to be determined.

At operation 455, the processing logic retrieves data associated with the cell from the cellular sites database 252A. At least a portion of this data can include engineering parameters associated with the cell as well as associated with neighbor cells.

At operation 460, the processing logic cleans data errors and converts or formats the data into a proper format to be ready to undergo feature engineering at operation 470. In some embodiments, operation 460 is also performed in an AWS® Glue task.

At operation 470, the processing logic performs feature engineering on the formatted data to generate the plurality of engineering parameters for input to the machine learning model. More specifically, the processing logic, in performing feature engineering on the formatted data, can include adding data insights to the formatted data and creating input data having structured features (e.g., related to the engineering parameters) prepared to undergo machine learning related to those features. In some embodiments, operation 470 is also performed in an AWS® Glue task.

At operation 480, the processing logic executes the ML model (e.g., out of the ML model storage) 250 with inputs including a plurality of engineering parameters associated with the cell.

At operation 484, the processing logic detects, in outputs of the machine learning model, the identity of each neighbor cell having the probability that satisfies a threshold probability for the cell. The threshold probability can be tuned to a particular sensitivity to including a neighbor cell as a related neighbor cell for purposes of cellular device handoffs. In embodiments, the relations estimates are stored in the cellular neighbor relations database 252B.

At operation 490, the processing logic optionally also causes the relation estimates (such as in a list of related neighbor cells) to be displayed in the UI 215 so as to inform the requesting user which neighbor cells satisfy the threshold probability and thus could be considered related neighbor cells. In some embodiments, the processing logic also causes a list of related neighbor cells for the cell to be transmitted to one or more subscriber devices that connect to the cellular network 120 via the cell. In embodiments, the list includes corresponding geo-locations of the related neighbor cells.

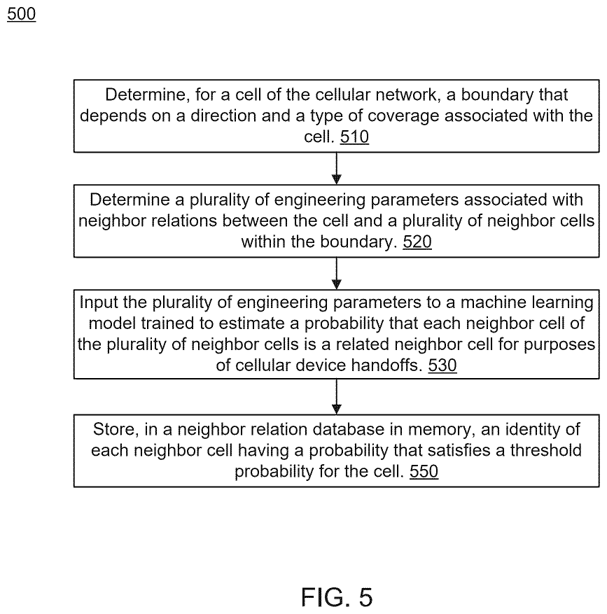

FIG. 5 is a flow chart of an example method 500 for identifying related neighbor cells of the particular cell within the cellular network using the ML model according to some embodiments. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 500 is performed by the computing system 150 of FIGS. 1A-1B or the computing system 200 of FIG. 2. The method 500 can also be performed by other computing systems described herein, such as described with reference to FIG. 8. The operations of the method 500 can be performed in an order other than that specifically illustrated and may be performed with fewer than all operations.

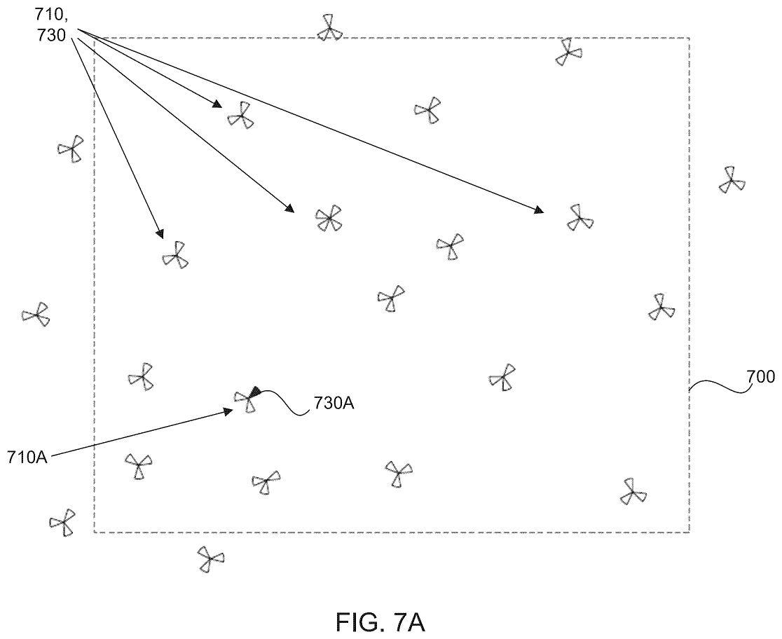

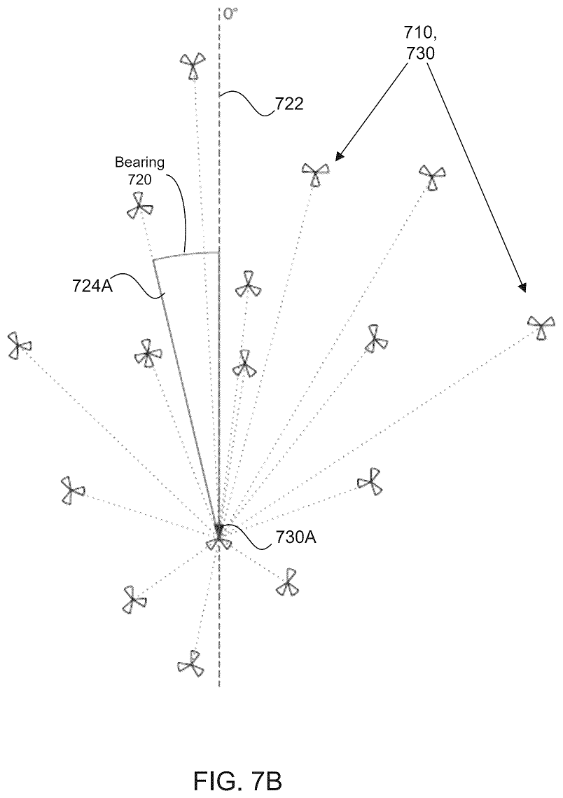

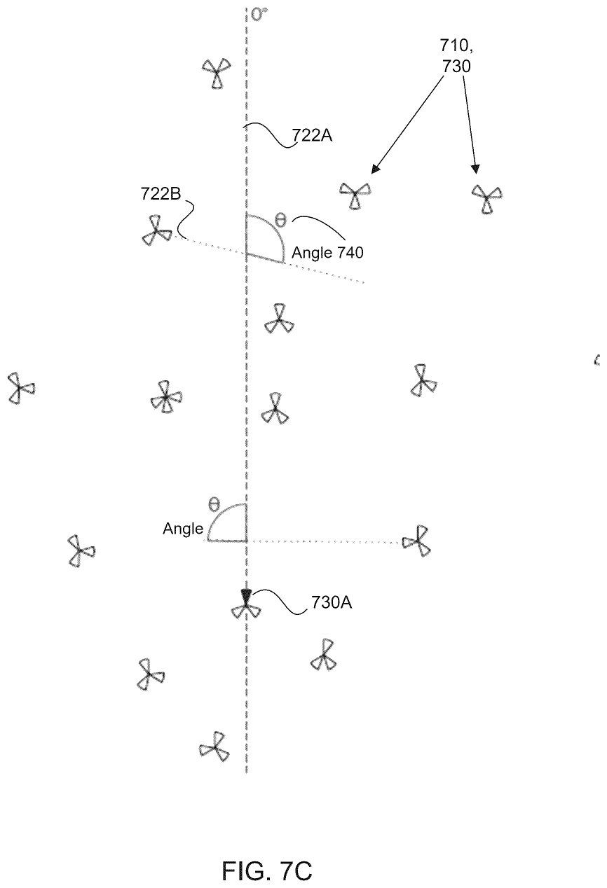

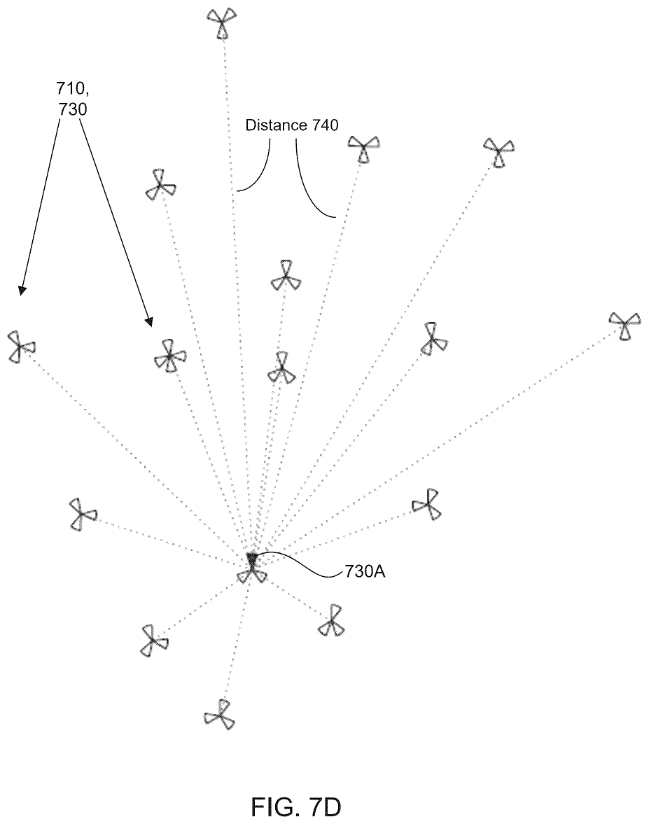

At operation 510, the processing logic determines, for a cell of the cellular network 120, a boundary that depends on a direction and a type of coverage associated with the cell, which will be discussed in more detail with reference to FIG. 7A.

At operation 520, the processing logic determines a plurality of engineering parameters associated with neighbor relations between the cell and a plurality of neighbor cells within the boundary. In some embodiments, determining the plurality of engineering parameters includes determining a combination of site locations, antenna tilts, antenna azimuths, and frequency bands for the cell and for the plurality of neighbor cells.

At operation 530, the processing logic inputs the plurality of engineering parameters to a machine learning (ML) model trained to estimate a probability that each neighbor cell of the plurality of neighbor cells is a related neighbor cell for purposes of cellular device handoffs, which was discussed in more detail with reference to FIG. 4B.

At operation 540, the processing logic stores, in a neighbor relation database in memory, an identity of each neighbor cell having a probability that satisfies a threshold probability for the cell which is discussed in more detail with reference to FIG. 4B.

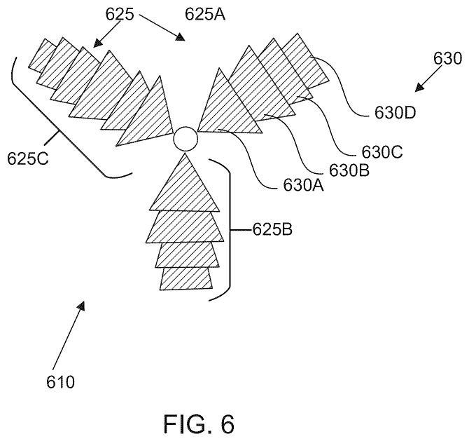

FIG. 6 illustrates a plurality of indicators for cells and sectors of an active site 610 of the cellular network presentable through a user interface (UI) according to some embodiments. In this example, the active site 610A can include three sectors 625, e.g., a first sector 625A, a second sector 625B, and a third sector 625C. Each sector can be orientated at approximately 120 degrees apart, or other equidistant value to minimize cross-cell interference between sectors, pointing in different directions, referred to as azimuths. In other embodiments, the sectors are not equidistant from each other. Each sector can include multiple cell indicators 630, typically between two and six cell indicators per sector corresponding to the actual cells, which are configurable depending on traffic demand among other factors.

As illustrated, the first sector 625A includes a first cell indicator 630A of a first cell, a second cell indicator 630B for a second cell, a third cell indicator 630C for a third cell, and a fourth cell indicator 630D for a fourth cell. Further, a frequency band deployed by each cell in a sector can be a different frequency band to increase overall capacity of the sector. In some embodiments, a separate cell indicator can be used for a different band if a cell is able to multiplex between bands, for example. In this way, the capacity/connectivity data can be organized according to sector and cell of each site, the cells within each sector include between two and six different frequency bands.

FIG. 7A illustrates a technique for identifying a boundary 700 for a cell useable to identify neighbor cell relations of a plurality of neighbor cells 730 according to at least some embodiments. For example, the particular cell under neighbor relations analysis can be a cell 730A of an active site 710A and the plurality of neighbor cells 730 can be cells associated with sectors of a plurality of active sites 710 (see FIG. 6).

In some embodiments, the operation 510 (FIG. 5) can be extended to the processing logic directing the boundary in the direction to which an antenna of the cell 730A is pointed and encompassing, within the boundary 700, a threshold number of neighbor cells before finalizing an extent of the boundary. This threshold number of neighbor cells can be those closest to the particular cell 730A considering geography, morphology, type of terrain, and the like. Further, the threshold number of neighbor cells are those referred to as the plurality of neighbor cells 730 in operation 520 of FIG. 5, which are within the boundary 700. Thus, once the threshold number of cells has been met with a particular surrounding group of active sites 710, that group of cells is closed as the pool from which neighbor relations are considered.

In some embodiments, further with reference to operation 520 of FIG. 5, the processing logic, to determine the plurality of engineering parameters, includes determining a bearing angle 720 (FIG. 7B), a difference angle 740 (FIG. 7C), and a distance 750 (FIG. 7D) between cells, which can individually or as a group be included with the engineering parameters used for performing inference of neighbor relations.

FIG. 7B illustrates determining a bearing angle 720 between the cell 730A and each respective neighbor cell of the plurality of neighbor cells 730 according to some embodiments. Thus, for example, an azimuth 722 is determined for the cell 730A and is designated as zero degrees (0°) while a bearing line 724A is determined for each of the plurality of neighbor cells 730 as between each neighbor cell and the cell 730A. In this way, each bearing angle 720 is determined between the azimuth 722 and a respective bearing line for each of the plurality of neighbor cells 730. Each bearing angle 720 can be stored as an engineering parameter in the cellular sites database 252A indexed against the cell 730A and a corresponding one of the plurality of neighbor cells 730 (and/or sectors). In some embodiments, neighbor cells with bearing angles of approximately 180 degrees (and thus generally behind the cell 730A) are eliminated from the plurality of neighbor cells 730.

FIG. 7C illustrates determining a difference angle 740 between a first azimuth 722A of the cell 730A and a second azimuth 722B of each respective neighbor cell of the plurality of neighbor cells 730 according to some embodiments. Thus, in this embodiment, the first azimuth 722A of the cell 730A is still zero degrees (or 0°) while the second azimuth 722B of each respective neighbor cell is analyzed relative to the first azimuth 722A to determine the difference angle 740 for each neighbor cell. Each difference angle 740 can be stored as an engineering parameter in the cellular sites database 252A indexed against the cell 730A and a corresponding one of the plurality of neighbor cells 730 (and/or sectors). In some embodiments, neighbor cells with difference angles of approximately 90, 270, or 180 degrees are eliminated from the plurality of neighbor cells 730 as not having sufficient cellular signal overlap with the cell 730.

FIG. 7D illustrates determining a distance 750 between the cell 730A and each respective neighbor cell of the plurality of neighbor cells 730. As illustrated, the distance 750 can be understood as an inter-cell distance between the cell 730A and each other neighbor cell or as an inter-site distance between the active site 710A and each active site that contains the other neighbor cell of the plurality of neighbor cells 730 being analyzed. In either case, the distance can be determined as a distance between latitude/longitude locations of the cell 730A and each of the plurality of neighbor cells 730.

FIG. 8 illustrates a block diagram illustrating an exemplary computer device 800 (or computing device), in accordance with implementations of the present disclosure. Computer device 800 can correspond to the computing system 150 (or device), as described above. Example computer device 800 can be connected to other computer devices in a LAN, an intranet, an extranet, and/or the Internet. Computer device 800 can operate in the capacity of a server in a client-server network environment. Computer device 800 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 800 can include a processing device 802 (also referred to as a processor, CPU, or GPU), a volatile memory 804 (or main memory, e.g., read-only memory (ROM), flash memory, dynamic random access memory (DRAM) such as synchronous DRAM (SDRAM), etc.), a non-volatile memory 806 (e.g., flash memory, static random access memory (SRAM), etc.), and a secondary memory (e.g., a data storage device 816), which can communicate with each other via a bus 830.

Processing device 802 (which can include processing logic 822) represents one or more general-purpose processing devices such as a microprocessor, central processing unit, or the like. More particularly, processing device 802 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 can also be one or more special-purpose processing devices such as an ASIC, a FPGA, a digital signal processor (DSP), network processor, or the like. In accordance with one or more aspects of the present disclosure, processing device 802 can be configured to execute instructions performing the method disclosed herein.

Example computer device 800 can further comprise a network interface device 808, which can be communicatively coupled to a network 820. Example computer device 800 can further comprise a video display 810 (e.g., a LCD (liquid crystal display) or organic light-emitting diode (OLED) monitor, a virtual-reality (VR) or augmented-reality (AR) display, a touch screen, or a cathode ray tube (CRT)), an alphanumeric input device 812 (e.g., a keyboard), a cursor control device 814 (e.g., a mouse, track ball, or touch pad), and an acoustic signal generation device 818 (e.g., a speaker). Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Data storage device 816 can include a computer-readable storage medium 824 (or, more specifically, a non-transitory computer-readable storage medium) on which is stored one or more sets of executable instructions 826 (e.g., processor-readable instructions). In accordance with one or more aspects of the present disclosure, executable instructions 826 can comprise executable instructions performing the method disclosed herein.

Executable instructions 826 (or processor-readable instructions) can also reside, completely or at least partially, within volatile memory 804 and/or within processing device 802 during execution thereof by example computer device 800, volatile memory 804 and processing device 802 also constituting computer-readable storage media. Executable instructions 826 can further be transmitted or received over a network via network interface device 808.

While the computer-readable storage medium 824 is shown in FIG. 8 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system to determine inter-cell neighbor relations of a cellular network, comprising:
one or more processing devices; and
memory communicatively coupled with and readable by the one or more processing devices and having stored therein processor-readable instructions which, when executed by the one or more processing devices, cause the one or more processing devices to perform operations comprising:
determining, for a cell of the cellular network, a boundary that depends on a direction and a type of coverage associated with the cell;
determining a plurality of engineering parameters associated with neighbor relations between the cell and a plurality of neighbor cells within the boundary;
inputting the plurality of engineering parameters to a machine learning model trained to estimate a probability that each neighbor cell of the plurality of neighbor cells is a related neighbor cell for purposes of cellular device handoffs; and
storing, in a neighbor relation database in memory, an identity of each neighbor cell having a probability that satisfies a threshold probability for the cell.

2. The computing system of claim 1, wherein determining the boundary comprises:
directing the boundary in the direction to which an antenna of the cell is pointed; and
encompassing, within the boundary, a threshold number of neighbor cells before finalizing an extent of the boundary.

3. The computing system of claim 1, wherein determining the plurality of engineering parameters comprises determining a combination of site locations, antenna tilts, antenna azimuths, and frequency bands for the cell and for the plurality of neighbor cells.

4. The computing system of claim 1, wherein determining the plurality of engineering parameters comprises determining at least one of:
a bearing angle between the cell and each respective neighbor cell of the plurality of neighbor cells;
a difference angle between a first azimuth of the cell and a second azimuth of each respective neighbor cell of the plurality of neighbor cells; or
a distance between the cell and each respective neighbor cell of the plurality of neighbor cells.

5. The computing system of claim 1, wherein the operations further comprise training the machine learning model using the plurality of engineering parameters retrieved from a portion of the cellular network in which neighbor relations are known.

6. The computing system of claim 1, wherein the operations further comprise causing a list of related neighbor cells for the cell to be transmitted to one or more subscriber devices that connect to the cellular network via the cell, wherein the list includes corresponding geo-locations of the related neighbor cells.

7. The computing system of claim 1, wherein the operations further comprise:
receiving, via a user interface, selection of an indicator of the cell for which to obtain neighbor relation predictions;
cleaning and formatting data, retrieved from a cellular neighbor relations database, to generate formatted data;
performing feature engineering on the formatted data to generate the plurality of engineering parameters for input to the machine learning model; and
detecting, in outputs of the machine learning model, the identity of each neighbor cell having the probability that satisfies the threshold probability for the cell.

8. A method comprising:
determining, by a computing system for a cell of a cellular network, a boundary that depends on a direction and a type of coverage associated with the cell;
determining a plurality of engineering parameters associated with neighbor relations between the cell and a plurality of neighbor cells within the boundary;
inputting the plurality of engineering parameters to a machine learning model trained to estimate a probability that each neighbor cell of the plurality of neighbor cells is a related neighbor cell for purposes of cellular device handoffs; and
storing, by the computing system, in a neighbor relation database in memory, an identity of each neighbor cell having a probability that satisfies a threshold probability for the cell.

9. The method of claim 8, wherein determining the boundary comprises:
directing the boundary in the direction to which an antenna of the cell is pointed; and
encompassing, within the boundary, a threshold number of neighbor cells before finalizing an extent of the boundary.

10. The method of claim 8, wherein determining the plurality of engineering parameters comprises determining a combination of site locations, antenna tilts, antenna azimuths, and frequency bands for the cell and for the plurality of neighbor cells.

11. The method of claim 8, wherein determining the plurality of engineering parameters comprises determining at least one of:
a bearing angle between the cell and each respective neighbor cell of the plurality of neighbor cells;
a difference angle between a first azimuth of the cell and a second azimuth of each respective neighbor cell of the plurality of neighbor cells; or
a distance between the cell and each respective neighbor cell of the plurality of neighbor cells.

12. The method of claim 8, further comprising training the machine learning model using the plurality of engineering parameters retrieved from a portion of the cellular network in which neighbor relations are known.

13. The method of claim 8, further comprising causing a list of related neighbor cells for the cell to be transmitted to one or more subscriber devices that connect to the cellular network via the cell, wherein the list includes corresponding geo-locations of the related neighbor cells.

14. The method of claim 8, further comprising:
receiving, via a user interface, selection of an indicator of the cell for which to obtain neighbor relation predictions;
cleaning and formatting data, retrieved from a cellular neighbor relations database, to generate formatted data;
performing feature engineering on the formatted data to generate the plurality of engineering parameters for input to the machine learning model; and
detecting, in outputs of the machine learning model, the identity of each neighbor cell having the probability that satisfies the threshold probability for the cell.

15. A non-transitory computer-readable storage medium storing instructions, which when executed by one or more processing devices of a computing system, causes the one or more processing devices to perform operations comprising:
determining, for a cell of a cellular network, a boundary that depends on a direction and a type of coverage associated with the cell;
determining a plurality of engineering parameters associated with neighbor relations between the cell and a plurality of neighbor cells within the boundary;
inputting the plurality of engineering parameters to a machine learning model trained to estimate a probability that each neighbor cell of the plurality of neighbor cells is a related neighbor cell for purposes of cellular device handoffs; and
storing, in a neighbor relation database in memory, an identity of each neighbor cell having a probability that satisfies a threshold probability for the cell.

16. The non-transitory computer-readable storage medium of claim 15, wherein determining the boundary comprises:
directing the boundary in the direction to which an antenna of the cell is pointed; and
encompassing, within the boundary, a threshold number of neighbor cells before finalizing an extent of the boundary.

17. The non-transitory computer-readable storage medium of claim 15, wherein determining the plurality of engineering parameters comprises determining a combination of site locations, antenna tilts, antenna azimuths, and frequency bands for the cell and for the plurality of neighbor cells.

18. The non-transitory computer-readable storage medium of claim 15, wherein determining the plurality of engineering parameters comprises determining at least one of:
a bearing angle between the cell and each respective neighbor cell of the plurality of neighbor cells;
a difference angle between a first azimuth of the cell and a second azimuth of each respective neighbor cell of the plurality of neighbor cells; or
a distance between the cell and each respective neighbor cell of the plurality of neighbor cells.

19. The non-transitory computer-readable storage medium of claim 15, wherein the operations further comprise causing a list of related neighbor cells for the cell to be transmitted to one or more subscriber devices that connect to the cellular network via the cell, wherein the list includes corresponding geo-locations of the related neighbor cells.

20. The non-transitory computer-readable storage medium of claim 15, wherein the operations further comprise:
receiving, via a user interface, selection of an indicator of the cell for which to obtain neighbor relation predictions;
cleaning and formatting data, retrieved from a cellular neighbor relations database, to generate formatted data;
performing feature engineering on the formatted data to generate the plurality of engineering parameters for input to the machine learning model; and
detecting, in outputs of the machine learning model, the identity of each neighbor cell having the probability that satisfies the threshold probability for the cell.
